(19) United States
(12) Patent Application Publication
(10) Pub. No.: US 2003/0081378 A1
(43) Pub. Date: May 1, 2003

(54) Disk drive carrier for use in a disk storage system

(75) Inventors: Barry J. Debbins, Lancaster, NY (US); Christopher Herkey, Cheektowaga, NY (US); Louis Majchrzak, West Seneca, NY (US); David A. Snell, Youngstown, NY (US)

Correspondence Address: Peter K. Sommer, Esq., Phillips, Lytle, Hitchcock, Blaine & Huber LLP, Intellectual Property Group, 3400 HSBC Center, Buffalo, NY, 14203, US

(73) Assignee: ATTO Technology, Inc.

(21) Appl. No.: 09/999,100

(22) Filed: Oct. 31, 2001

(51) Int. Cl. G06F 1/16; G11B 33/02

(52) U.S. Cl. 361/685; 361/683; 369/75.1; 369/80

(57) ABSTRACT

The present invention provides an improved disk drive carrier (10) for use in a disk storage system. The disk drive carrier includes a plurality of disk drives (11A, 11B) secured to a single printed circuit board (13), and a connector (14) with at least one input/output interface portion (22). In some aspects of the invention, the disk drives are ATA disk drives or Serial ATA disk drives. In other aspects of the invention, the disk drive carrier includes a single connector. In other aspects of the invention, the connector includes a bus portion (21), and in others, the bus portion (21) includes at least one I²C bus. Other aspects of the invention include non-volatile memory (15), power controlled circuitry (16), LEDs (23A, 23B, 24) and electrode-static discharge strips (17A, 17B, 17C). The present invention provides such a disk drive carrier compatible with industry-standard rack systems.

### TECHNICAL FIELD

The present invention relates generally to computer systems, and, more particularly, to disk storage systems and disk drive carriers for use in disk storage systems.

### BACKGROUND ART

Disk drives are used to store information and data in millions of computer systems worldwide. Virtually every personal computer and server contains one or more internal disk drives. In addition, disk drives are often configured as independent disk storage systems, such as RAID (“Redundant Array of Inexpensive Disks”) arrays and JBOD (“Just a Bunch of Disks”) arrays, which are external to the personal computers, servers, or other hosts with which they are associated. The low cost and relatively high density of ATA and Serial ATA disk drives has resulted in their use in many disk storage systems.

The high cost of space in office buildings and data centers, among other things, has created an ever-increasing demand for high-density disk storage systems. High-density disk storage systems are capable of storing significant amounts of information in a relatively small amount of space. These systems frequently include ATA or Serial ATA disk drives because, among other things, they can provide higher density storage relative to their principal alternatives, SCSI (“Small Computer System Interface”) and Fibre Channel drives.

Many disk storage systems, especially those used in dedicated data centers, are configured in “racks.” Such racks include two or more openings of a common size and configuration wherein equipment, such as disk drives or groups of disk drives, may be inserted and connected together to form a disk storage system or array. Over time, industry-standard rack sizes or “platforms” have developed. One common platform is commonly referred to as “19-inch rack.” In a 19-inch rack, the width of the entire disk storage system is 19 inches. The height of the individual racks which are stacked in the system varies, but is always denominated in units referred to as “U's,” where one “U” is equal to 1.75 inches. All equipment designed for use in 19-inch racks must be of a height which is an integer multiple of U's. Such equipment includes disk drive carriers holding one or more disk drives.

Prior art discloses storage systems containing a plurality of disk drive carriers. Such disk drives carriers include at least one connector which interfaces with a corresponding connector on a midplane card or host, creating an electrical connection between the disk drives mounted on the carrier and the midplane card or host. Prior art, however, does not efficiently utilize the fixed space existing in a rack system. Moreover, prior inventions utilize multiple printed circuit boards for each disk drive carrier and require one connector for each disk drive secured to the carrier.

In addition, existing disk drive carriers fail to utilize the capabilities of the computers, servers or other hosts with which they are associated. For example, many host systems include an Inter-IC or “I²C” bus, which provides a communication path between integrated circuits. The inclusion of a connection to one or more I²C buses in a disk drive carrier permits communication between a midplane card, motherboard or other host and electronic circuitry or memory on the disk drive carrier, which communication is not otherwise available through an ATA interface, and not available in the prior art.

Therefore, a need exists for a disk drive carrier having a single printed circuit board which is capable of holding two or more disk drives, and which makes effective use of the space available in a disk storage system. A need also exists for improved communications, and data and information transfer, between disk drive carriers and associated hosts.

### DISCLOSURE OF THE INVENTION

With parenthetical reference to the corresponding parts, portions or surfaces of the disclosed embodiment, merely for purposes of illustration and not by way of limitation, the present invention provides an improved disk drive carrier (10) for use in a disk storage system. The disk drive carrier includes a plurality of disk drives (11A, 11B) secured to a single printed circuit board (13), and a connector (14) with an input/output interface portion (22), which connector is mounted on the printed circuit board (13) and electrically connected to each of the disk drives (11A, 11B).

In another aspect of the invention, the disk drives (11A, 11B) are ATA disk drives. In another aspect, the disk drives (11A, 11B) are Serial ATA disk drives.

In another aspect of the invention, the connector (14) mounted on the printed circuit board (13) is the sole connector, and the connector has a single input/output interface portion (22).

In another aspect of the invention, the connector (14) includes a bus portion (21). In other aspects, the bus portion (21) includes at least one I²C bus.

The present invention in one aspect includes a single connector (14) having a single bus portion (21). In another aspect, that single bus portion (21) includes at least one I²C bus.

In another aspect of the invention, the bus portion (21) of the connector (14) is capable of transferring information to the disk drive carrier (10) from a host associated with the disk drive carrier, and from the disk drive carrier to the associated host, wherein the disk drive carrier (10) includes non-volatile memory (15). In one aspect of the invention, information transferred between the disk drive carrier (10) and associated host is stored in the non-volatile memory (15).

In another aspect of the invention, the disk drives (11A, 11B) are each associated with a different serial number, and the information transferred between the disk drive carrier (10) and associated host, and stored in the non-volatile memory (15), includes at least one serial number. In another aspect, the information transferred through the bus portion (21) between the disk drive carrier and associated host, and stored in the non-volatile memory (15), includes data reflecting the configuration of the disk drives (11A, 11B). In another aspect, the information transferred between the disk drive carrier (10) and associated host, and stored in the non-volatile memory (15), includes data reflecting the history of error conditions encountered in the disk drives (11A, 11B).

In another aspect of the invention, the disk drive carrier (10) includes at least one electro-static discharge strip (17A, 17B, 17C) which is operatively arranged to ground static electricity on the disk drive carrier when the disk drive carrier is moved relative to, i.e. inserted into and removed from, a disk storage system, e.g. a rack having a plurality of openings of a standard size and format.

In another aspect of the invention, the disk storage system with which the disk drive carrier (10) is associated includes a rack with a plurality of openings of a standard size and format, wherein the disk drive carrier (10) is complementarily configured and is so constructed and arranged as to be selectively insertable into one of the openings. In yet another aspect of the invention, the disk drive carrier is so constructed and arranged as to be selectively insertable into one of the openings in a 19-inch rack.

In another aspect of the invention, the disk drive carrier (10) has a plurality of LEDs (23A, 23B, 24). In one aspect of the invention, at least one of the LEDs reflects the operational status, i.e. activity, of the disk drives (11A, 11B). In another aspect, at least one of the LEDs (24) reflects error conditions encountered in the disk drives (11A, 11B).

In still another aspect of the invention, the disk storage system is connected to a power source and the disk drive carrier (10) includes electronic circuitry (16) selectively operable to control the supply of power to each of the disk drives (11A, 11B).

The general object of the invention is to provide high density disk drive storage in the fixed amount of space available in a disk storage system, e.g., an industry-standard platform such as a 19-inch rack.

Another object is to provide a disk drive carrier with a single connector adapted to interface with a midplane card, motherboard or other host. Another object is to provide a disk drive carrier with two or more disk drives secured to a single printed circuit board.

Another object is to protect the disk storage system from the effects of the build up of electrostatic charges on the disk drive carrier.

Another object is to provide visual indicators, i.e. LEDs, of activity in the disk drives and errors encountered by the disk drives.

Another object is to permit hot-swapping of the disk drive carriers within a disk storage system.

Another object is to permit, through power control circuitry affixed to the disk drive carrier, the control of the supply of power to each of the disk drives on the disk drive carrier for purposes such as decreasing power consumption, decreasing heat generation, reducing wear and tear, and avoiding simultaneous power surges to multiple disk drives.

Still another object of the invention is to provide for efficient storage and retrieval of disk management information and data associated with the disk drives in a disk drive carrier, such as disk drive serial numbers, disk configuration data, and data reflecting the history of error conditions encountered by the disk drives.

These and other objects and advantages will become apparent from the foregoing and ongoing written specification, the accompanying drawings and the appended claims.

### BRIEF DESCRIPTION OF THE DRAWINGS

FIG. 1 shows in top plan view the disk drive carrier of the present invention.

FIG. 2 shows a side elevational view of the disk drive carrier of the present invention.

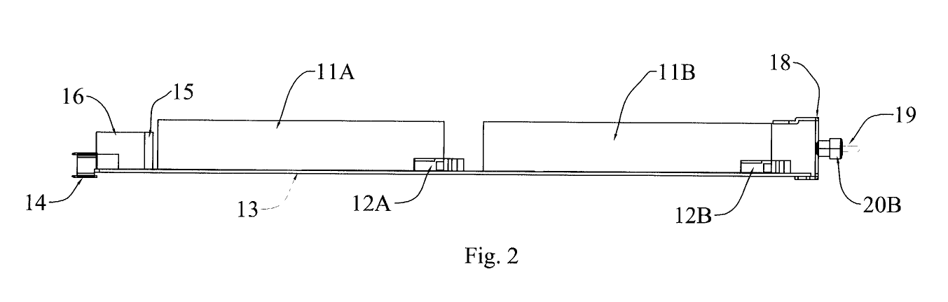

FIG. 3 shows a rear elevational view of the disk drive carrier of the present invention.

FIG. 4 shows a front elevational view of the face plate and associated elements of the present invention.

### DESCRIPTION OF THE PREFERRED EMBODIMENTS

At the outset, it should be clearly understood that like reference numerals are intended to identify the same structural elements, parts, portions or surfaces consistently throughout the several drawing figures, as such elements, parts, portions or surfaces may be further described or explained by the entire written specifications, of which this detailed description is an integral part. Unless otherwise indicated, the drawings are intended to be read together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

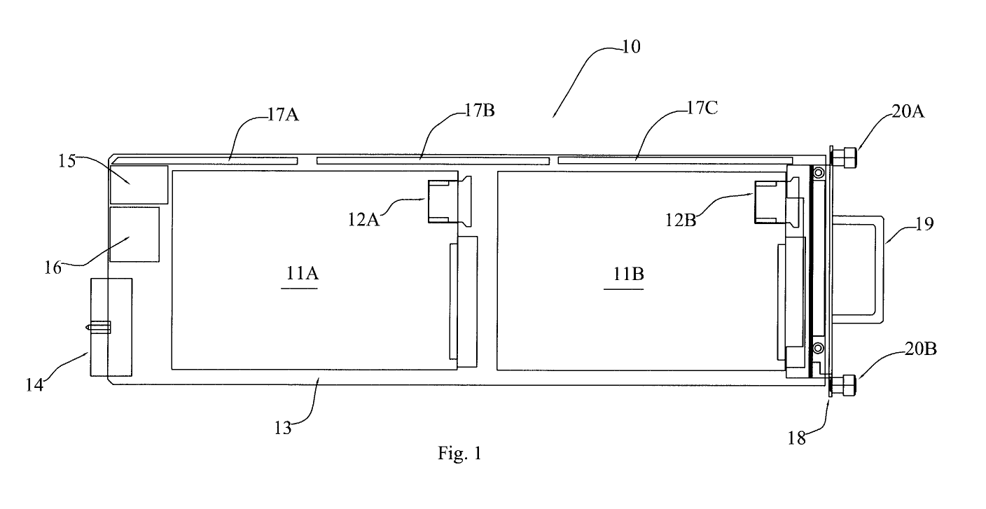

Referring now to the drawings, the present invention provides an improved disk drive carrier, of which a presently preferred embodiment is generally indicated at 10. In FIG. 1, the disk drive carrier is shown as having two ATA disk drives 11A, 11B secured to a single printed circuit board 13. Each of the ATA disk drives 11A, 11B has a single ATA controller 12A, 12B.

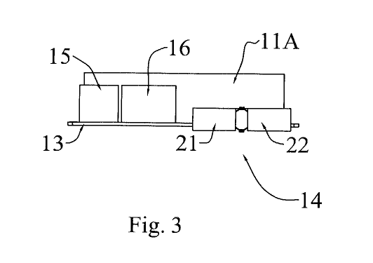

A single connector 14, which is electrically connected to each of the ATA disk drives 11A, 11B through two ATA controllers 12A, 12B, is mounted on the printed circuit board 13. As depicted in FIG. 3, the connector 14 includes an I²C bus portion 21 for communication between the associated host and memory 15 and electronic circuitry, 16 attached to the printed circuit board 13, and an input/output interface portion 22 for the transfer of data between the disk drive and the host.

In the embodiment of FIG. 1, the invention includes non-volatile memory 15 mounted on the printed circuit board 13. The non-volatile memory 15 is electrically connected to the bus portion 21 of the connector 14, which bus portion 21 is shown in FIG. 3. This embodiment also includes power supply circuitry 16 which is mounted on the printed circuit board 13 and electrically connected to the bus portion 21 of the connector 14.

In addition, this embodiment has three electrostatic discharge strips 17A, 17B, 17C which are affixed to the printed circuit board 13.

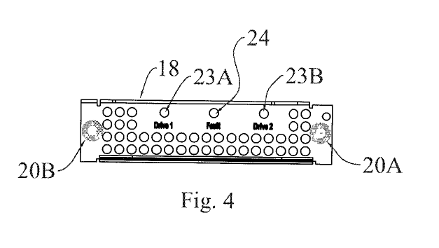

The preferred embodiment further includes a face plate 18 which is secured to the printed circuit board 13, which face plate is further depicted in FIG. 4. Three LEDs 23A, 23B, 24, which are mounted on and electrically connected to the printed circuit board 13 and the bus portion 21 of the connector 14, are visible through three openings in the face plate 18. One of the LEDs 23A reflects the operational status, i.e. activity, of one of the disk drives 11A, and a second LED 23B reflects the operational status, i.e. activity, of the other disk drive 11B. A third LED 24 indicates whether either of the disk drives 11A, 11B have encountered error conditions.

This embodiment further includes a handle 19 for use in inserting and removing the disk drive carrier 10 from an associated disk storage system, and mounting pins 20A, 20B for securing the disk drive carrier 10 to such a system.

Modifications

The present invention contemplates that many changes and modifications may be made. For example, the number of disk drives secured to the disk drive carrier may be readily varied, subject only to space limitations imposed by disk storage systems and associated racks and openings. The number of LEDs and their location and configuration may be readily varied. Likewise, the number of electro-static discharge strips, and their location, may be varied. Serial ATA disk drives, and alternatives to ATA and Serial ATA disk drives, may replace the ATA disk drives depicted. Therefore, while there has been described what is believed to be the preferred embodiment of the present invention, those skilled in the art will recognize that other and further changes and modifications may be made thereto without departing from the spirit of the invention. Therefore, the invention is not limited to the specific details and representative embodiments shown and described herein. In the following claims, preamble language that is not specifically referred to in the body of a particular claim is to be construed as a mere statement of intended use and not as a limitation. Accordingly, various modifications may be made without departing from the spirit or scope of the general inventive concept as defined and differentiated by the following claims.

What is claimed is:

1. A disk drive carrier for use in a disk storage system associated with a host, comprising: a single printed circuit board; a plurality of disk drives, said disk drives being secured to said printed circuit board; and a connector having at least one input/output interface portion, said connector being mounted on said printed circuit board and electrically connected to each of said disk drives.

2. The disk drive carrier as set forth in claim 1 wherein said disk drives are ATA disk drives.

3. The disk drive carrier as set forth in claim 1 wherein said disk drives are Serial ATA disk drives.

4. The disk drive carrier as set forth in claim 1 wherein said connector is the sole connector, and wherein said connector has at least one input/output interface portion.

5. The disk drive carrier as set forth in claim 4 wherein said connector comprises a bus portion.

6. The disk drive carrier as set forth in claim 4 wherein said bus portion comprises at least one I² C bus.

7. The disk drive carrier as set forth in claim 1 wherein said connector comprises a bus portion.

8. The disk drive carrier as set forth in claim 7 wherein said bus portion comprises at least one I²C bus.

9. The disk drive carrier as set forth in claim 7 wherein said connector is the sole connector and wherein said connector has a single bus portion.

10. The disk drive carrier as set forth in claim 9 wherein said bus portion comprises at least one I²C bus.

11. The disk drive carrier as set forth in claim 7 wherein said bus portion is capable of transferring information to said disk drive carrier from said host, and from said disk drive carrier to said host, and wherein said disk drive carrier comprises non-volatile memory.

12. The disk drive carrier as set forth in claim 11 wherein said information is stored in said non-volatile memory.

13. The disk drive carrier as set forth in claim 12 wherein said disk drives are associated with a serial number, and wherein said information includes at least one serial number.

14. The disk drive carrier as set forth in claim 12 wherein said information includes data reflecting the configuration of said disk drives.

15. The disk drive carrier as set forth in claim 12 wherein said information includes data reflecting error conditions encountered in said disk drives.

16. The disk drive carrier as set forth in claim 1 wherein said disk storage system comprises a rack having a plurality of openings of a standard size and format, further comprising at least one electro-static discharge strip operatively arranged to ground static electricity on said disk drive carrier when said disk drive carrier is moved relative to said rack.

17. The disk drive carrier as set forth in claim 1 wherein said disk storage system comprises a rack having a plurality of openings of a standard size and format, and wherein said disk drive carrier is complementarity configured and is so constructed and arranged as to be selectively insertable into one of said openings.

18. The disk drive carrier as set forth in claim 17 wherein said rack is a 19-inch rack and said disk drive carrier has a height of 5.25 inches.

19. The disk drive carrier as set forth in claim 1 wherein said disk drive carrier comprises a plurality of LEDs.

20. The disk drive carrier as set forth in claim 19 wherein at least one of said LEDs reflects the operational status of each of said disk drives.

21. The disk drive carrier as set forth in claim 19 wherein at least one of said LEDs reflects error conditions encountered in said disk drives.

22. The disk drive carrier as set forth in claim 1 wherein said disk storage system is connected to a power source, and wherein said disk drive carrier includes electronic circuitry selectively operable to control the supply of power to each of said disk drives.
